(19) United States
(12) Patent Application Publication
(10) Pub. No.: US 2022/0268664 A1
(43) Pub. Date: Aug. 25, 2022

(54) POLARITY TEST SYSTEM AND METHOD USED FOR MULTI-FIBER OPTICAL CABLES

(71) Applicant: COMMSCOPE TECHNOLOGIES LLC, Hickory, NC (US)

(72) Inventors: Zhengxin MA, Shanghai (CN); Zongsheng LENG, Shanghai (CN); Xiaodong ZHANG, Suzhou (CN); Hang LI, Suzhou (CN)

(73) Assignee: COMMSCOPE TECHNOLOGIES LLC, Hickory, NC (US)

(21) Appl. No.: 17/675,720

(22) Filed: Feb. 18, 2022

(30) Foreign Application Priority Data
Feb. 19, 2021 (CN) 202110191068.2

(51) Int. Cl. G01M 11/08; G02B 6/26; G01M 11/00

(52) U.S. Cl. CPC G01M 11/088; G02B 6/262; G01M 11/33

(57) ABSTRACT

The present disclosure relates to a polarity test system and method used for MPO optical cables, and provides a polarity test system used for MPO optical cables, where the MPO optical cable comprises a first end-face, a second end-face and a plurality of optical fibers extended between the first end-face and the second end-face, with each optical fiber comprising a first end arranged at the first end-face and a second end arranged at the second end-face. The system comprises: a light source, configured to irradiate the first end-face of the MPO optical cable so that the light transmitted from the light source enters the optical fibers from the first end of the optical fibers and leaves the optical fibers from the second end of the optical fibers; a baffle, set between the light source and the first end-face that can move relative to the first end-face to block the first end of one or a plurality of optical fibers, and configured to change the nature of light received by the optical fibers which first end is blocked by the baffle; and a detection device, configured to detect the light output by the second end of each optical fiber as the baffle moves relative to the first end-face.

### CROSS REFERENCE TO RELATED APPLICATION

This application claims priority and the benefit of Chinese Patent Application No. 202110191068.2, filed Feb. 19, 2021, which application is incorporated herein by reference in its entirety.

### TECHNICAL FIELD

The present disclosure generally relates to a multi-fiber cable, such as a multi-fiber push on (MPO) optical cable, and more specifically, the present disclosure relates to a polarity test system and method used for multi-fiber optical cables.

### BACKGROUND

MPO optical cables are a type of high-density fiber-optic transmission cable which can have a 12-core, 24-core, 48-core, 72-core, 144- and many other core number designs; in which, 12-core and 24-core cables are the most common. Optical fiber cores can be arranged in one row (such as 12-core cables) or multiple rows (such as 24-core and higher cables) at each end-face of the MPO optical cable based on different core number designs.

MPO optical cable polarity refers to the compatibility between the transmitting end (TX) and receiving end (RX) of the MPO optical cable. Examples of common types of MPO optical cable polarity include: Type A, as shown in FIG. 1A, where the arrangement and position of the optical fiber cores at both ends of the MPO optical cable are the same, that is, 1 at one end corresponds to 1 at the other end and 2 at one end corresponds to 2 at the other end, . . . , 12 at one end corresponds to 12 at the other end; Type B, as shown in FIG. 1B, where the arrangement and position of optical fiber cores at both ends of the MPO optical cable are the opposite, that is, 1 at one end corresponds to 12 at the other end, 2 at one end corresponds to 11 at the other end, . . . , 12 at one end corresponds to 1 at the other end; Type C, as shown in FIG. 1C, where the positions of a pair of adjacent optical fiber cores are alternate, that is, 1 at one end corresponds to 2 at the other end, 2 at one end corresponds to 1 at the other end, 3 at one end corresponds to 4 at the other end, 4 at one end corresponds to 3 at the other end, . . . , 11 at one end corresponds to 12 at the other end, and 12 at one end corresponds to 11 at the other end; etc. Of course, MPO optical cables can also have other types of polarity to accommodate different application scenarios.

MPO optical cable polarity tests are of utmost importance to the correct application of MPO optical cables, so it is an indicator that must be tested for MPO optical cables.

### SUMMARY

According to an aspect of the present disclosure, a polarity test system used for MPO optical cables is provided, where this MPO optical cable comprises a first end-face, a second end-face and a plurality of optical fibers extended between the first end-face and the second end-face, with each optical fiber comprising a first end arranged at the first end-face and a second end arranged at the second end-face, and this polarity test system comprises: a light source, configured to irradiate the first end-face of the MPO optical cable so that the light transmitted from the light source enters this plurality of optical fibers from the first end of this plurality of optical fibers and leaves this plurality of optical fibers from the second end of this plurality of optical fibers; a baffle, set between the light source and the first end-face of the MPO optical cable that can move relative to the first end-face to block the first end of one or a plurality of optical fibers among this plurality of optical fibers, and this baffle is configured to change the nature of light received by the optical fibers which first end is blocked by the baffle among this plurality of optical fibers; and a detection device, configured to detect the light output by the second end of each optical fiber among this plurality of optical fibers as the baffle moves relative to the first end-face.

In some embodiments, the polarity test system further comprises: a processing device, configured to determine the polarity of the MPO optical cable based on the detection results of the detection device and the sequence in which the first ends are blocked by the baffle.

In some embodiments, the polarity test system further comprises: a processing device, configured to determine the polarity of the MPO optical cable based on the detection results of the detection device and the direction in which the baffle moves relative to the first end-face.

In some embodiments, the polarity test system further comprises: a processing device, configured to determine the polarity of the MPO optical cable based on the detection results of the detection device and the position of the baffle relative to the first end-face.

In some embodiments, the baffle is configured to attenuate the intensity of light received by the optical fiber which first end is blocked by the baffle among this plurality of optical fibers.

In some embodiments, the baffle is configured to change the wavelength of the light received by the optical fiber among this plurality of optical fibers which first end is blocked by the baffle.

In some embodiments, the detection device is an imaging device, where this imaging device is configured to capture images of the second end-face of the MPO optical cable as the baffle moves relative to the first end-face.

In some embodiments, the detection device comprises a plurality of detection units, with each detection unit configured to receive light output from a corresponding second end among the second ends of this plurality of optical fibers.

In some embodiments, the number of optical fibers which first end is blocked by the baffle among this plurality of optical fibers increases as the baffle moves relative to the first end-face, or the number of optical fibers which first end is blocked by the baffle among this plurality of optical fibers decreases as the baffle moves relative to the first end-face.

In some embodiments, the first ends at different positions on the first end-face are blocked by the baffle as the baffle moves relative to the first end-face.

In some embodiments, the first end of this plurality of optical fibers is arranged in multiple rows at the first end-face, and the second end of this plurality of optical fibers is arranged in multiple rows at the second end-face, with the number of rows of first ends being the same as that of second ends.

In some embodiments, the baffle is configured to block different numbers of first ends in all rows of first ends when the baffle at least partially blocks the first ends at the first end-face.

In some embodiments, the baffle is configured to block first ends at different positions in all rows of first ends when the baffle at least partially blocks the first ends at the first end-face.

According to another aspect of the present disclosure, a polarity test method used for MPO optical cables is provided, where this MPO optical cable comprises a first end-face, a second end-face and a plurality of optical fibers extended between the first end-face and the second end-face, with each optical fiber comprising a first end arranged at the first end-face and a second end arranged at the second end-face, and this polarity test method comprises: irradiating the first end-face of the MPO optical cable so that light can enter this plurality of optical fibers through the first end of this plurality of optical fibers and leave this plurality of optical fibers through the second end of this plurality of optical fibers; moving the baffle relative to the first end-face to block the first end of one or a plurality of optical fibers among this plurality of optical fibers, where this baffle is configured to change the nature of light received by the optical fiber which first end is blocked by the baffle among this plurality of optical fibers; detecting the light output by the second end of each optical fiber among this plurality of optical fibers as the baffle moves relative to the first end-face; and determining the polarity of the MPO optical cable based on the detection results.

In some embodiments, the polarity of the MPO optical cable is determined based on the detection results and the sequence in which the first ends are blocked by the baffle.

In some embodiments, the polarity of the MPO optical cable is determined based on the detection results and the direction in which the baffle moves relative to the first end-face.

In some embodiments, the polarity of the MPO optical cable is determined based on the detection results and the position of the baffle relative to the first end-face.

Through the following detailed description of exemplary embodiments of the present disclosure by referencing the attached drawings, other features and advantages of the present disclosure will become clearer.

### BRIEF DESCRIPTION OF THE DRAWINGS

The foregoing and other features and advantages of the present disclosure will become clear from the following descriptions of the embodiments of the present disclosure shown in conjunction with the attached drawings. The attached drawings are incorporated herein and form a part of the Specification to further explain the principles of the present disclosure and enable those skilled in the art to make and use the present disclosure. In which:

FIG. 1A to FIG. 1C schematically illustrate the polarity of Type A, Type B, and Type C MPO optical cables, respectively.

FIG. 2 to FIG. 4 schematically show the polarity test system used for MPO optical cables according to some embodiments of the present disclosure.

FIG. 5A to FIG. 5H schematically depict the testing of a Type A 12-core MPO optical cable by the polarity test system according to some embodiments of the present disclosure.

FIG. 6A to FIG. 6D schematically depict the testing of a Type B 12-core MPO optical cable by the polarity test system according to some embodiments of the present disclosure.

FIG. 7A to FIG. 7F schematically depict the testing of a Type C 12-core MPO optical cable by the polarity test system according to some embodiments of the present disclosure.

FIG. 8A to FIG. 8D schematically depict the testing of a Type A 12-core MPO optical cable by the polarity test system according to other embodiments of the present disclosure.

FIG. 9A to FIG. 9D schematically depict the testing of a Type A 24-core MPO optical cable by the polarity test system according to other embodiments of the present disclosure.

FIG. 10A to FIG. 10D schematically depict examples of the baffle used by the polarity test system according to some other embodiments of the present disclosure.

FIG. 11 schematically shows the flowchart of the polarity test method used for MPO optical cables according to some embodiments of the present disclosure.

Note, in the embodiments described below, the same signs are sometimes used in common between different attached drawings to denote the same parts or parts with the same functions, and repeated descriptions thereof are omitted. In some cases, similar labels and letters are used to indicate similar items. Therefore, once an item is defined in one attached drawing, it does not need to be further discussed in subsequent attached drawings.

For ease of understanding, the position, dimension, and range of each structure shown in the attached drawings and the like may not indicate the actual position, dimension, and range. Therefore, the present disclosure is not limited to the positions, dimensions, and ranges disclosed in the attached drawings and the like.

### DETAILED DESCRIPTION

Various exemplary embodiments of the present disclosure will be described in detail below by referencing the attached drawings. It should be noted: unless otherwise specifically stated, the relative arrangement, numerical expressions and numerical values of components and steps set forth in these embodiments do not limit the scope of the present disclosure.

The following description of at least one exemplary embodiment is actually only illustrative, and in no way serves as any limitation to the present disclosure and its application or use. In other words, the structure and method herein are shown in an exemplary manner to illustrate different embodiments of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those of ordinary skill in the art may not be discussed in detail, but where appropriate, the technologies, methods, and equipment should be regarded as part of the granted Specification.

In all examples shown and discussed herein, any specific value should be construed as merely exemplary value and not as limiting value. Therefore, other examples of the exemplary embodiment may have different values.

It should be noted that the attached drawings depicted in the present disclosure merely schematically show relative positional relations of the respective components of the system according to the embodiments of the present disclosure, and unless otherwise specified, the specific structure of each component is not particularly limited. It should also be noted that the system may further comprise additional components that are neither discussed herein nor shown in the attached drawings so as to avoid obscuring the main points of the present disclosure.

MPO optical cables are integrated multi-core optical cables and the production and manufacturing process is relatively complicated, which causes its production cost to be high and also requires the testing of many indicators during its testing process. However, the more times a MPO optical cable is used in its testing process, the easier it is to get damaged. MPO optical cable polarity tests are of utmost importance to the correct application of MPO optical cables, so it is an indicator that must be tested for MPO optical cables. However, MPO optical cable polarity tests often use contact test methods. In order to inject light into the MPO optical cable to be tested, one end of the MPO optical cable to be tested usually needs to be connected to a test lead, the plurality of optical fibers comprising the MPO optical cable is then connected via this test lead to a plurality of sub-fibers separated from each other, so as to respectively connect them to the corresponding light source to receive light individually. In addition, to detect the light from different optical fibers comprising the MPO optical cable to be tested, the other end of the MPO optical cable to be tested shall be connected to another test lead, and the plurality of optical fibers comprising the MPO optical cable shall be respectively connected via this test lead to a plurality of sub-fibers separated from each other, so as to respectively connect them to the corresponding detector to detect light individually. However, using a test lead tends to cause damage and/or contamination to the end-face of the MPO optical cable, and misuse of the test lead also causes test errors. Moreover, MPO optical cables with different core number design often need to be equipped with dedicated test leads. In addition, in this case, a pair of light sources and detectors need to be used for each optical fiber, causing the testing cost to be high, particularly for MPO optical cables with a high core number design. Even if only one pair of light sources and detectors is used to detect each optical fiber sequentially, it results in a long testing time and requires continuous adjustment of the optical path connection.

The polarity test system and polarity test method used for MPO optical cables provided in the present disclosure can accurately and quickly test the polarity of MPO optical cables at a low cost and using a non-contact method, effectively preventing MPO optical cables from being damaged or contaminated during polarity testing, and they can be easily adapted to MPO optical cables with various core number designs. The polarity test system used for MPO optical cables will first be described in detail below according to the present disclosure with reference to the attached drawings.

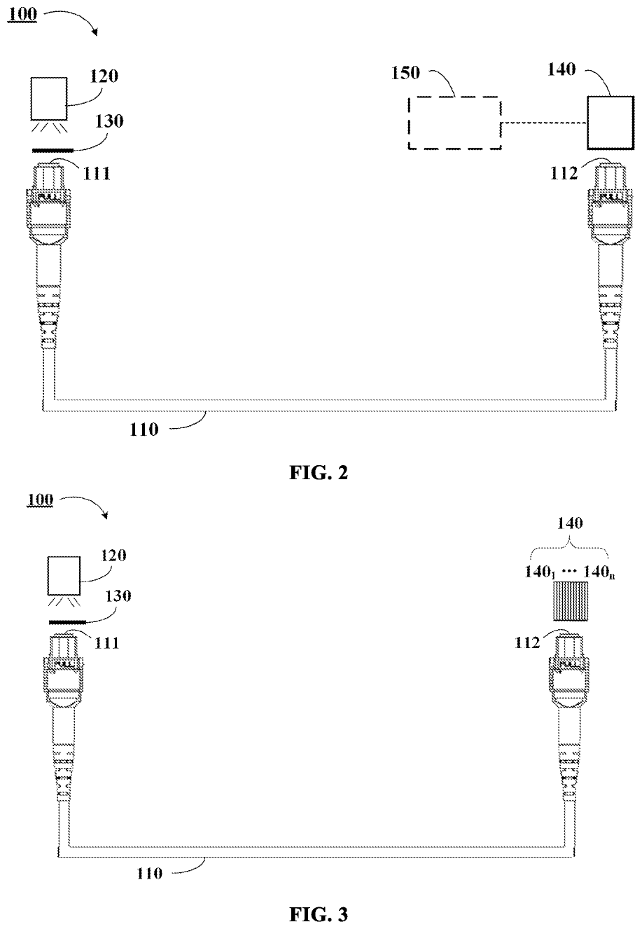

FIG. 2 schematically shows the polarity test system 100 used for the MPO optical cable 110 according to some embodiments of the present disclosure. As shown in FIG. 2, the MPO optical cable 110 to be tested comprises a first end-face 111 and a second end-face 112. The MPO optical cable 110 further comprises a plurality of optical fibers (not shown) extended between the first end-face 111 and the second end-face 112, and each optical fiber comprises a first end arranged at the first end-face 111 and a second end arranged at the second end-face 112. Although the compatibility between the various first ends at the first end-face 111 and the various second ends at the second end-face 112 of the MPO optical cable 110 to be tested (that is, polarity of the MPO optical cable) is unknown, the respective arrangement of the first ends and second ends at their corresponding end-faces is usually known. For example, the respective arrangement of the first ends and the second ends of the optical fibers at their corresponding end-faces in the MPO optical cable 110 is usually determined by the core number of the MPO optical cable 110. If the MPO optical cable 110 has 12 cores, the first ends and second ends of these optical fibers are usually respectively arranged in one row at their corresponding end-faces; if the MPO optical cable 110 has 24 cores, the first ends and second ends of these optical fibers are usually respectively arranged in two rows at their corresponding end-faces; etc.

The polarity test system 100 may comprise a light source 120, a baffle 130, and a detection device 140.

The light source 120 can be configured to irradiate the first end-face 111 of the MPO optical cable 110 so that the light transmitted from the light source 120 enters the plurality of optical fibers from the first end of these optical fibers via the MPO optical cable 110 and leaves these optical fibers from the second end of these optical fibers. The light source 120 can have a sufficiently large luminous area so that it is able to cover the entire first end-face 111 of the MPO optical cable 110. In other words, without being blocked, the light source can be set in a way that allows every optical fiber comprising the MPO optical cable 110 to receive light. In addition, the light source 120 can have a sufficiently high luminous intensity to conduct the entire optical fibers in the MPO optical cable 110, that is, light transmitted from the light source 120 still has an intensity that can be detected when it enters the optical fibers from the first end of the optical fibers and leaves the second end of the optical fibers. The light source 120 can be any suitable light source. For example, it can be a white light source and can also be a monochromatic light source, as long as it can achieve the purpose of the present disclosure. If the distance between the light source 120 and the first end-face 111 of the MPO optical cable 110 is too far, it may cause the intensity of the light received by the first end-face 111 to be insufficient, and if it is too near, it may cause the intensity of light received at different positions on the first end-face 111 to be uneven, so a suitable distance between the light source 120 and the first end-face 111 of the MPO optical cable 110 may be set based on the actual situation.

The baffle 130 can be set between the light source 120 and the first end-face 111 of the MPO optical cable 110 and it can move relative to the first end-face 111 to block the first end of one or a plurality of optical fibers in the MPO optical cable 110. The baffle 130 is preferably set parallel to the first end-face 111 of the MPO optical cable 110, but it can also form an angle within a suitable range with the first end-face 111 of the MPO optical cable 110. For example, an angle below 10°, below 5°, or below 1°. In addition, the baffle 130 can be set as close to the first end-face 111 of the MPO optical cable 110 as possible without being in contact with the first end-face 111 of the MPO optical cable 110. For example, the distance between the baffle 130 and the first end-face 111 of the MPO optical cable 110 may be within the range of 2-3 mm. For example, the baffle 130 can have a sheet structure or other suitable structures.

The baffle 130 can be configured to change the nature of light received by the optical fibers which first end is blocked by the baffle 130 among the plurality of optical fibers of the MPO optical cable 110.

In some embodiments, the baffle 130 can be configured to attenuate the intensity of light received by the optical fiber which first end is blocked by the baffle 130. In some examples, the baffle 130 can be configured to completely block the optical fibers blocked by the baffle 130 from transmission by the light source 120. For example, the baffle 130 can be made of materials that do not allow light transmitted by the light source 120 to pass through. In some examples, the baffle 130 can be configured to attenuate the intensity of light received by the optical fiber which first end is blocked by the baffle 130 until the intensity of light that propagates through this optical fiber and leaves the second end of this optical fiber cannot be detected by the detection device 140. In some examples, the baffle 130 can be configured to attenuate the intensity of light received by the optical fiber which first end is blocked by the baffle 130 until the difference in the intensity of light output from the second end of this optical fiber and the intensity of light output from the second end of an optical fiber which first end is not blocked by the baffle 130 can be distinguished by the detection device 140. For example, the baffle 130 can be made of materials that have a specific transmittance to light transmitted from the light source 120.

In addition, in some embodiments, the baffle 130 can be configured to change the wavelength of the light received by the optical fiber which first end is blocked by the baffle 130 in the MPO optical cable 110. For example, the baffle 130 can have optical filtering functions. For example, it may be a bandpass or bandstop filter. As a non-limiting example, the baffle 130 may be a red bandpass filter. When the light source 120 is a white light source, an optical fiber which first end is not blocked by the baffle 130 receives white light, while the optical fiber which first end is blocked by the baffle 130 receives red light. As such, the detection device 140 can distinguish whether the first end blocked by the baffle 130 or the first end not blocked by the baffle 130 corresponds to the second end based on the wavelength of light output by the second end of each optical fiber. For example, where the detection device 140 is a camera and this camera can shoot images of the second end-face 112 of the MPO optical cable 110, in which, the second end corresponding to the first end blocked by the baffle 130 is displayed as red light spots in this image, while the second end corresponding to a first end that is not blocked by the baffle 130 is displayed as white light spots in this image; another example is where the detection device 140 comprises a photoelectric conversion unit array set with a blue bandpass filter, in which, barely any signal can be detected at the second end corresponding to the first end blocked by the baffle 130, while a signal can be detected at the second end corresponding to a first end that is not blocked by the baffle 130.

In addition, in some embodiments, the baffle 130 can be configured to change the state of polarization or other nature of the light received by the optical fiber which first end is blocked by the baffle 130 in the MPO optical cable 110. Accordingly, the light source 120 and detection device 140 can also be changed adaptively to distinguish whether the second end corresponds to the first end blocked by the baffle 130 or a first end that is not blocked by the baffle 130.

The relative movement between the baffle 130 and the first end-face 111 of the MPO optical cable 110 changes the first ends on the first end-face 111 that are blocked by the baffle 130 accordingly. Preferably, the baffle 130 is movable, while the light source 120 and MPO optical cable 110 are fixed. As such, the relative position between the light source 120 and the first end-face 111 of the MPO optical cable 110 can always be kept fixed, so that the state of light received is constant when the first end of every optical fiber is not blocked by the baffle 130, and this can also ensure that the polarity test system 100 has minimal movable components, thereby simplifying the system. In some embodiments, the baffle can be installed on a movable mechanical component, such as a motor-driven mobile station. In other embodiments, the relative movement between the baffle 130 and the first end-face 111 of the MPO optical cable 110 can also be caused by the movement of the first end-face 111 of the MPO optical cable 110 when the baffle 130 is stationary. In some embodiments, a part of the MPO optical cable 110 that at least comprises the first end-face 111 can be fixed on the movable mechanical component (such as a motor-driven mobile station). In this case, in order to keep the relative position of the light source 120 and the first end-face 111 of the MPO optical cable 110 fixed, the light source 120 can also be fixed on this movable mechanical component.

There are no special limitations on the direction of movement of the baffle 130 relative to the first end-face 111 of the MPO optical cable 110 and the specific shape of the baffle 130, as long as the movement of the baffle 130 relative to the first end-face 111 of the MPO optical cable 110 causes the first end of different optical fibers in the MPO optical cable 110 to be blocked by the baffle 130. That is, the present disclosure focuses on the sequence in which the first ends are blocked by the baffle as decided by the movement of the baffle 130 relative to the first end-face 111 of the MPO optical cable 110, which causes changes in the distribution of the first ends blocked by the baffle 130 on the first end-face 111 of the MPO optical cable 110. This distribution includes the number and position, etc. of first ends blocked by the baffle 130. The direction of the movement of the baffle 130 relative to the first end-face 111 of the MPO optical cable 110 and the shape of the baffle 130 can be specifically set based on this purpose, and this will be described in further detail later in the text.

In some embodiments, the number of optical fibers which first end is blocked by the baffle 130 among a plurality of optical fibers of the MPO optical cable 110 increases as the baffle 130 moves relative to the first end-face 111, or the number of optical fibers which first end is blocked by the baffle 130 among a plurality of optical fibers of the MPO optical cable 110 decreases as the baffle 130 moves relative to the first end-face 111. In some embodiments, the first ends at different positions on the first end-face 111 are blocked by the baffle 130 as the baffle 130 moves relative to the first end-face 111. In some embodiments, the first ends on the first end-face 111 take turns to be blocked by the baffle 130 or take turns to be exposed as the baffle 130 moves relative to the first end-face 111.

In addition, as mentioned above, in some embodiments, the first end of a plurality of optical fibers of the MPO optical cable 110 is arranged in one row at the first end-face 111, and the second end of a plurality of optical fibers of the MPO optical cable 110 is also arranged in one row at the second end-face 112. However, in some other embodiments, the first end of a plurality of optical fibers of the MPO optical cable 110 is arranged in multiple rows at the first end-face 111, and the second end of a plurality of optical fibers of the MPO optical cable 110 is also arranged in multiple rows at the second end-face 112, with the number of rows of first ends being the same as that of second ends. Where the first end and second end of the optical fibers are respectively arranged in multiple rows at the corresponding end-faces, in some embodiments, the baffle 130 can be configured to block different numbers of first ends in all rows of first ends when the baffle 130 at least partially blocks the first ends at the first end-face 111, while in some other embodiments, the baffle 130 can be configured to block first ends at different positions in all rows of first ends when the baffle 130 at least partially blocks the first ends at the first end-face 111. As such, as the distribution of first ends in the respective rows blocked by the baffle 130 in all rows of first ends is different when the baffle 130 moves relative to the first end-face 111 of the MPO optical cable 110 to any position, it facilitates the subsequent distinguishing of the row where the first end corresponds to the second end.

The detection device 140 can be configured to detect the light output by the second end of each optical fiber among a plurality of optical fibers of the MPO optical cable 110 as the baffle 130 moves relative to the first end-face 111. For example, the detection device 140 can detect the light output by the second end of each optical fiber as the baffle 130 moves relative to the first end-face 111 through the spatial resolution method. This means that the detection results from the detection device 140 can confirm the position at which light is output from the second end on the second end-face 112 of the MPO optical cable 110.

In some embodiments, the detection device 140 may comprise a plurality of detection units, with each detection unit configured to receive the light from a corresponding second end among the second ends of a plurality of optical fibers of the MPO optical cable 110. As shown in FIG. 3, the detection device 140 may comprise a plurality of detection units, namely 140₁, . . . , 140ₙ, in which, n corresponds to the number of optical fibers in the MPO optical cable 110. Light output from the second end of different optical fibers can reach different detection units, so each detection unit can obtain information about the light output from the corresponding second end at the second end-face. These detection units 140₁, . . . , 140ₙ work together to concurrently obtain information about the light output of all the seconds ends at the second end-face at every moment. As a non-limiting example, the detection device 140 may comprise a photoelectric conversion element (such as a CMOS- or CCD-based element) array, and light output from the second end of different optical fibers can reach different photoelectric conversion elements of this array. For example, in some examples, the detection device 140 may comprise x photoelectric conversion element arrays, in which

$$x = {\sum }_{i = 1}^{n} {y}_{i} ,$$

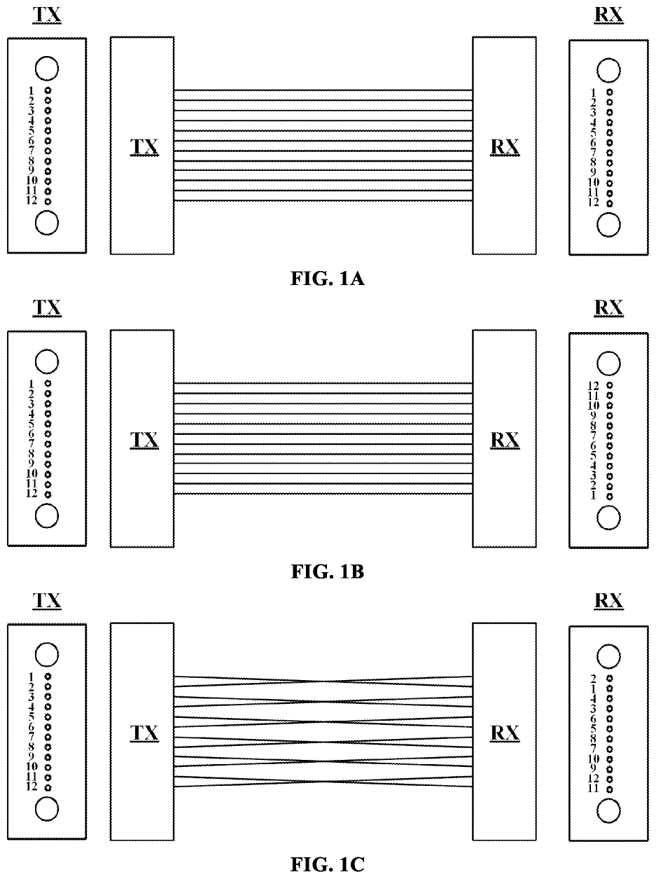

yᵢ is the number of allocated photoelectric conversion element arrays that are used to detect light output by a corresponding second end. For example, where the baffle 130 completely blocks out light, for Type A 12-core MPO optical cables (as shown in FIG. 1A), when only the first end 1 on the first end-face (TX) is blocked, this n set of photoelectric conversion element arrays (that is, corresponding to n detection units) can output signals (0, 1, 1, . . . , 1), in which 0 represents that the second end does not output light while 1 represents that the second end outputs light. When only the first ends 1 and 2 on the first end-face (TX) are blocked, this n set of photoelectric conversion element arrays can output signals (0, 0, 1, . . . , 1) and when all the first ends on the first end-face (TX) are blocked, this n set of photoelectric conversion element arrays can output signals (0, 0, 0, . . . , 0).

In some embodiments, the detection device 140 may be an imaging device, where this imaging device is configured to capture images of the second end-face 112 of the MPO optical cable 110 as the baffle 130 moves relative to the first end-face 111. For example, as shown in FIG. 4, the detection device 140 may be a camera. The images of the second end-face 112 of the MPO optical cable 110 captured by this camera includes images of the second end of every optical fiber, in which, images of the second end of the optical fibers may be of light spots representing light output from the second end of these optical fibers. As the baffle 130 moves relative to the first end-face 111, this camera can capture a series of images of the second end-face 112 of the MPO optical cable 110. In some embodiments, the imaging device may also capture dynamic images of the second end-face 112 of the MPO optical cable 110 when the baffle 130 moves relative to the first end-face 111.

Therefore, users of the polarity test system 100 can determine the polarity of the MPO optical cable based on the detection results of the detection device 140. For example, users can determine the polarity of the MPO optical cable based on the detection results of the detection device 140 and the sequence in which the first ends are blocked by the baffle 130. As the direction in which the baffle 130 moves relative to the first end-face 111 decides the sequence in which the first ends are blocked by the baffle 130, this causes changes to the light output by the second end based on the polarity of the MPO optical cable. Therefore, users can also determine the polarity of the MPO optical cable based on the detection results of the detection device 140 and the direction in which the baffle 130 moves relative to the first end-face 111. That is, users can determine the polarity of the MPO optical cable based on the relationship between changes in the detection results of the detection device 140 as the baffle 130 moves relative to the first end-face 111 and the direction in which the baffle 130 moves relative to the first end-face 111. In addition, users can also determine the polarity of the MPO optical cable based on the detection results of the detection device 140 and the position of the baffle 130 relative to the first end-face 111. For example, the baffle 130 is sequentially in a series of positions relative to the first end-face 111 and when the baffle 130 is at each position in this series of positions, the detection device 140 can obtain the corresponding detection results. Therefore, users can determine the polarity of the MPO optical cable based on the series of positions of the baffle 130 relative to the first end-face 111 and the corresponding series of detection results.

Optionally, the polarity test system 100 may further comprise a processing device 150 to help users of the polarity test system 100 determine the polarity test results. In some embodiments, the processing device 150 may be configured to determine the polarity of the MPO optical cable based on the detection results of the detection device 140 and the sequence in which the first ends are blocked by the baffle 130. In some embodiments, the processing device 150 may also be configured to determine the polarity of the MPO optical cable based on the detection results of the detection device 140 and the direction in which the baffle 130 moves relative to the first end-face 111. In some embodiments, the processing device 150 may also be configured to determine the polarity of the MPO optical cable based on the detection results of the detection device 140 and the position of the baffle 130 relative to the first end-face 111. As shown in FIG. 2, the processing device 150 may optionally be communicatively coupled to the detection device 140, and the processing device 150 may be any suitable computing device with processing functions, such as a computer, smart phone, tablet, or laptop. For example, when the detection device 140 is a camera, the processing device 150 may use any suitable algorithm to perform image recognition on the series of images of the second end-face 112 of the MPO optical cable 110 captured by this camera, so as to analyze the relationship between changes in the light output by the second ends on the second end-face 112 reflected by this series of images as the baffle 130 moves relative to the first end-face 111 and the direction in which the baffle 130 moves relative to the first end-face 111, thereby determining the polarity of the MPO optical cable. The baffle (or the first end-face of the MPO optical cable) can be moved by the movable mechanical component. For example, the processing device 150 can be communicatively coupled to this movable mechanical component for this movable mechanical component to obtain the direction (or position) in which the baffle 130 moves relative to the first end-face 111 by controlling the direction (or position) in which the baffle 130 moves relative to the first end-face 111 or obtaining the direction (or position) from this movable mechanical component. In some examples, the processing device 150 can receive at least one user input, including the direction (or position) in which the baffle 130 moves relative to the first end-face 111 and the detection results of the detection device.

Of course, with regard to the polarity test system 100, the shape of the baffle 130 is known. When the movement of the baffle 130 in the polarity test system 100 relative to the first end-face 111 (including the initial position and direction of movement) is specified in advance, the user or processing device 150 can directly determine the polarity of the MPO optical cable based on only the detection results of the detection device.

The method to use the polarity test system of the present disclosure to test the polarity of the MPO optical cable will be described in detail below. For the ease of description, the specific examples described in the text below will be illustrated using the examples of the baffle 130 fully blocking out light, the detection device 140 being a camera, the baffle 130 being movable, and the light source 120 and MPO optical cables 110 being fixed. However, as can be understood by those skilled in the art, these are only exemplary and not limiting.

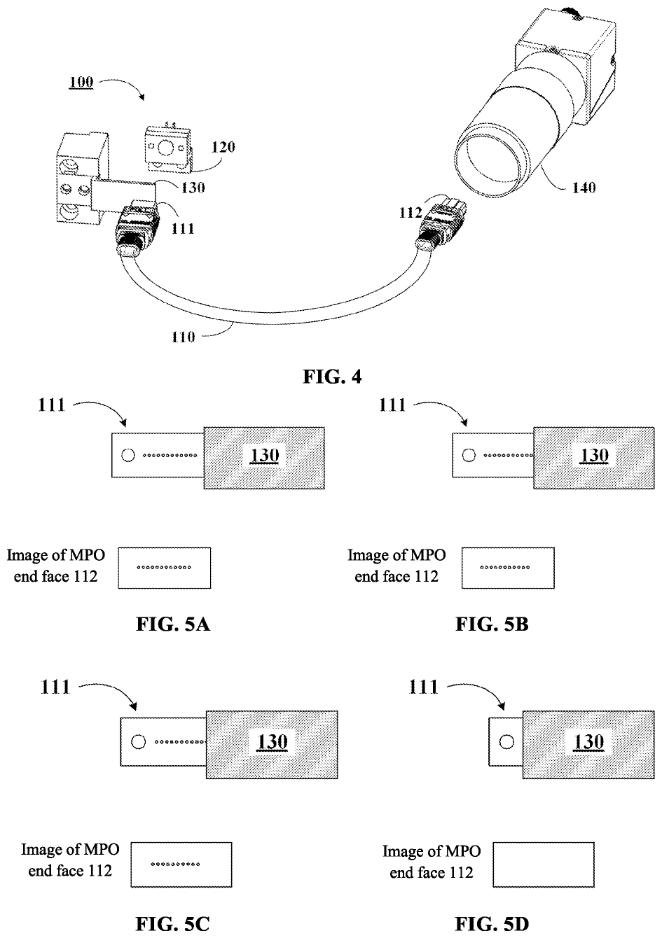

FIG. 5A to FIG. 5H schematically depict the testing of a Type A 12-core MPO optical cable by the polarity test system according to some embodiments of the present disclosure. In these figures, the baffle 130 is illustrated as a rectangle, but this is only exemplary and not limiting.

From FIG. 5A to FIG. 5D, the baffle 130 moves from right to left relative to the first end-face 111 in the plane of the illustration and the number of first ends blocked by the baffle 130 increases with the movement of the baffle 130. In FIG. 5A, the baffle 130 has yet to block the first end of any optical fiber, so the image of the second end-face 112 of the MPO optical cable captured by the detection device 140 includes 12 light spots. In FIG. 5B, the baffle 130 moves to the left until it blocks the rightmost first end on the first end-face 111, so the image of the second end-face 112 only has 11 light spots remaining on the left side. In FIG. 5C, the baffle 130 moves to the left until it blocks the two rightmost first ends on the first end-face 111, so the image of the second end-face 112 only has 10 light spots remaining on the left side. By this analogy, in FIG. 5D, the baffle 130 moves to the left until it blocks all the first ends, so the image of the second end-face 112 does not have light spots. Therefore, based on FIG. 5A to FIG. 5D, as the baffle 130 moves from right to left relative to the first end-face 111 in the plane of the illustration, the light spots in the images of the second end-face 112 also disappear sequentially from right to left, so we can determine that this 12-core MPO optical cable has Type A polarity.

From FIG. 5E to FIG. 5H, the baffle 130 moves from left to right relative to the first end-face 111 in the plane of the illustration and the number of first ends blocked by the baffle 130 decreases with the movement of the baffle 130. In FIG. 5E, the baffle 130 blocks all the first ends, so the image of the second end-face 112 does not have light spots. In FIG. 5F, the baffle 130 moves to the right until the leftmost first end on the first end-face 111 is exposed, so one light spot appears at the leftmost position in the image of the second end-face 112. In FIG. 5G, the baffle 130 moves to the right until the two leftmost first ends on the first end-face 111 are exposed, so two light spots appear at the leftmost position in the image of the second end-face 112. By this analogy, in FIG. 5H, the baffle 130 moves to the right until all the first ends are exposed, so 12 light spots appear in the image of the second end-face 112. Therefore, based on FIG. 5E to FIG. 5H, as the baffle 130 moves from left to right relative to the first end-face 111 in the plane of the illustration, the light spots in the images of the second end-face 112 also appear sequentially from left to right, so we can determine that this 12-core MPO optical cable has Type A polarity.

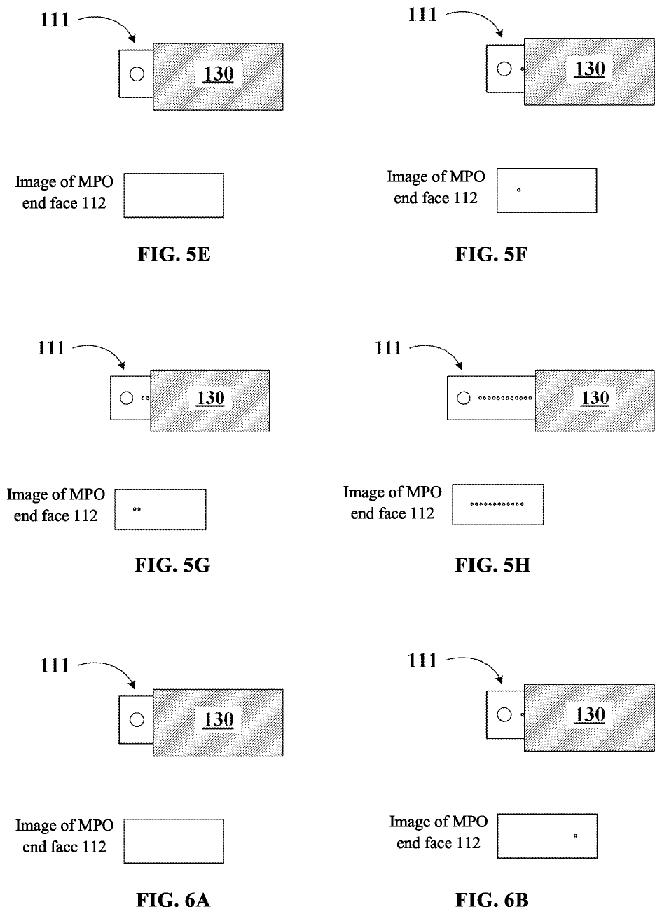

FIG. 6A to FIG. 6D schematically depict the testing of a Type B 12-core MPO optical cable by the polarity test system according to some embodiments of the present disclosure. From FIG. 6A to FIG. 6D, the baffle 130 moves from left to right relative to the first end-face 111 in the plane of the illustration and the number of first ends blocked by the baffle 130 decreases with the movement of the baffle 130. In FIG. 6A, the baffle 130 blocks all the first ends, so the image of the second end-face 112 does not have light spots. In FIG. 6B, the baffle 130 moves to the right until it blocks the leftmost first end on the first end-face 111, so one light spot appears at the rightmost position in the image of the second end-face 112. In FIG. 6C, the baffle 130 moves to the right until the two leftmost first ends on the first end-face 111 are exposed, so two light spots appear at the rightmost position in the image of the second end-face 112. By this analogy, in FIG. 6D, the baffle 130 moves to the right until all the first ends are exposed, so 12 light spots appear in the image of the second end-face 112. Therefore, based on FIG. 6A to FIG. 6D, as the baffle 130 moves from left to right relative to the first end-face 111 in the plane of the illustration, the light spots in the image of the second end-face 112 appear sequentially from right to left, so this 12-core MPO optical cable can be determined to have Type B polarity.

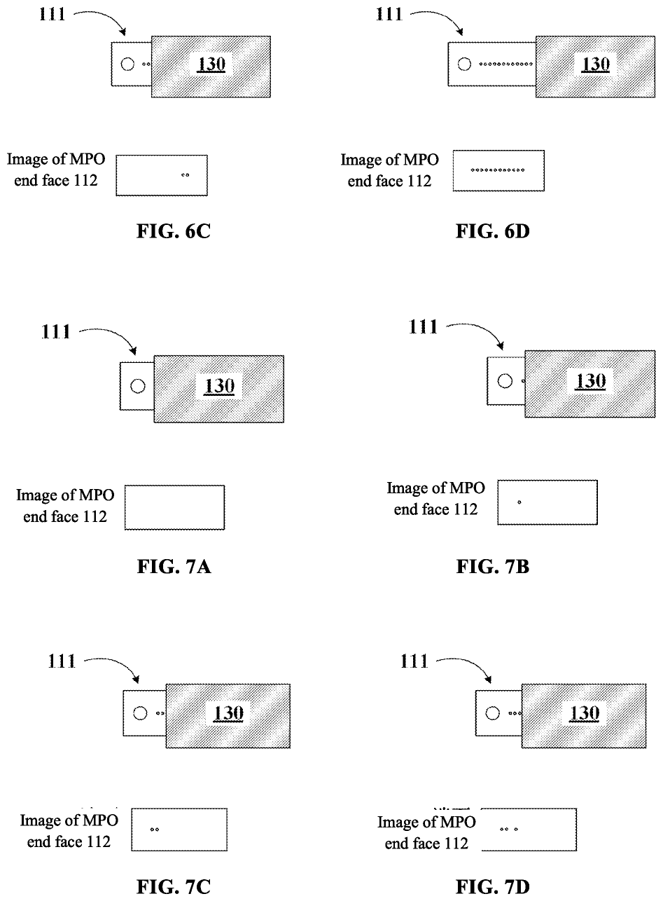

FIG. 7A to FIG. 7F schematically depict the testing of a Type C 12-core MPO optical cable by the polarity test system according to some embodiments of the present disclosure. From FIG. 7A to FIG. 7F, the baffle 130 moves from left to right relative to the first end-face 111 in the plane of the illustration and the number of first ends blocked by the baffle 130 deceases with the movement of the baffle 130. In FIG. 7A, the baffle 130 blocks all the first ends, so the image of the second end-face 112 does not have light spots. In FIG. 7B, the baffle 130 moves to the right until the leftmost first end on the first end-face 111 is exposed, so one light spot appears at the second position from the left in the image of the second end-face 112. In FIG. 7C, the baffle 130 moves to the right until the two leftmost first ends on the first end-face 111 are exposed, so two light spots appear at the leftmost position in the image of the second end-face 112. In FIG. 7D, the baffle 130 moves to the right until the three leftmost first ends on the first end-face 111 are exposed, so two light spots appear at the leftmost position and one light spot appear at the fourth position from the left in the image of the second end-face 112. In FIG. 7E, the baffle 130 moves to the right until the fourth leftmost first ends on the first end-face 111 are exposed, so four light spots appear at the leftmost position in the image of the second end-face 112. By this analogy, in FIG. 7F, the baffle 130 moves to the right until all the first ends are exposed, so 12 light spots appear in the image of the second end-face 112. Therefore, based on FIG. 7A to FIG. 7F, as the baffle 130 moves from left to right relative to the first end-face 111 in the plane of the illustration, light spots in the image of the second end-face 112 appear alternately from left to right with two light spots as one set, so this 12-core MPO optical cable can be determined to have Type C polarity.

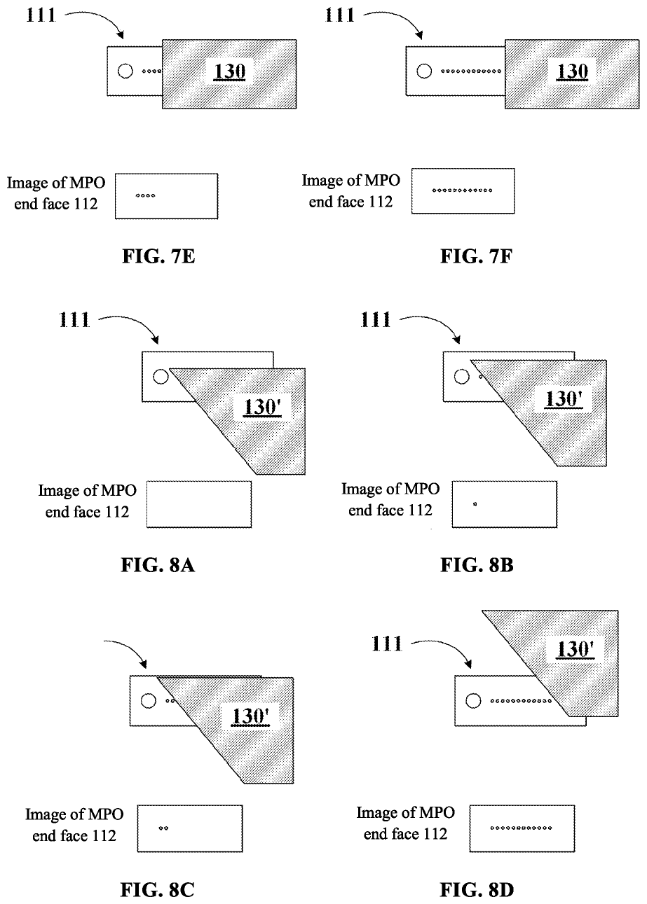

In the exemplary embodiments from FIG. 5A to FIG. 7F, the baffle 130 is illustrated as a rectangle and moves horizontally from left to right or from right to left in the plane of the illustration. FIG. 8A to FIG. 8D schematically depict the testing of a Type A 12-core MPO optical cable by the polarity test system according to other embodiments of the present disclosure, in which, the baffle 130′ is illustrated as having a diagonal (such as a trapezoid shown in the figure, and it can also be a triangle and other suitable shapes) and moves vertically in the plane of the illustration. This also further illustrates that there are no special limitations on the direction of movement of the baffle relative to the first end-face of the MPO optical cable and the specific shape of the baffle, as long as the movement of the baffle relative to the first end-face of the MPO optical cable causes the first end of different optical fibers in the MPO optical cable to be blocked by the baffle.

Specifically, from FIG. 8A to FIG. 8D, the baffle 130′ moves from bottom to top relative to the first end-face 111 in the plane of the illustration and the number of first ends blocked by the baffle 130′ decreases with the movement of the baffle 130′. In FIG. 8A, the baffle 130′ blocks all the first ends, so the image of the second end-face 112 does not have light spots. In FIG. 8B, the baffle 130′ moves upwards until the leftmost first end on the first end-face 111 is exposed, so one light spot appears at the leftmost position in the image of the second end-face 112. In FIG. 8C, the baffle 130′ moves upwards until the two leftmost first ends on the first end-face 111 are exposed, so two light spots appear at the leftmost position in the image of the second end-face 112. By this analogy, in FIG. 8D, the baffle 130′ moves upwards until all the first ends are exposed, so 12 light spots appear in the image of the second end-face 112. Therefore, based on FIG. 8A to FIG. 8D, as the baffle 130′ moves from bottom to top relative to the first end-face 111 in the plane of the illustration, the first ends on the first end-face 111 are exposed sequentially from left to right and light spots in the images of the second end-face 112 also appear sequentially from left to right, so this 12-core MPO optical cable can be determined to have Type A polarity. It can be understood that even if the baffle moves vertically or horizontally relative to the first end-face in the plane of the illustration, it can also move in other suitable directions.

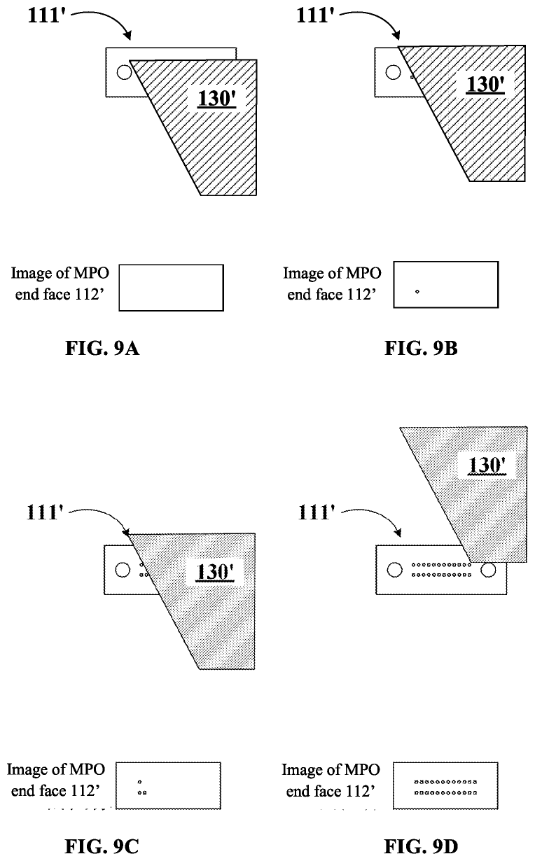

FIG. 9A to FIG. 9D schematically depict the testing of a Type A 24-core MPO optical cable by the polarity test system according to other embodiments of the present disclosure. In the examples of FIG. 9A to FIG. 9D, the baffle 130′ has a diagonal, so the number of first ends blocked by the baffle in the two rows of first ends on the first end-face 111′ of the 24-core MPO optical cable is always different, so different rows can be distinguished very well in the images of the second end-face 112. Specifically, from FIG. 9A to FIG. 9D, the baffle 130′ moves from bottom to top relative to the first end-face 111′ in the plane of the illustration and the number of first ends blocked by the baffle 130′ decreases with the movement of the baffle 130′. In FIG. 9A, the baffle 130′ blocks all the first ends, so the image of the second end-face 112′ does not have light spots. In FIG. 9B, the baffle 130′ moves upwards until the leftmost first end in the second row (bottom row) on the first end-face 111′ is exposed, so one light spot appears at the leftmost position in the second row in the image of the second end-face 112′. In FIG. 9C, the baffle 130′ moves upwards until the two leftmost first ends in the second row and the leftmost first end in the first row (top row) on the first end-face 111′ are exposed, so two light spots appear at the leftmost position in the second row and one light spot appears at the leftmost position in the first row in the image of the second end-face 112′. By this analogy, in FIG. 9D, the baffle 130′ moves upwards until all the first ends are exposed, so 24 light spots appear in the image of the second end-face 112′. Therefore, based on FIG. 9A to FIG. 9D, as the baffle 130′ moves from bottom to top relative to the first end-face 111′ in the plane of the illustration, the first ends in the second row on the first end-face 111′ are exposed sequentially from left to right and the first ends of the first row are also exposed sequentially from left to right, so the light spots in the second row in the image of the second end-face 112′ also appear sequentially from left to right and the light spots in the first row also appear sequentially from left to right. Thus, this 24-core MPO optical cable can be determined to have Type A polarity.

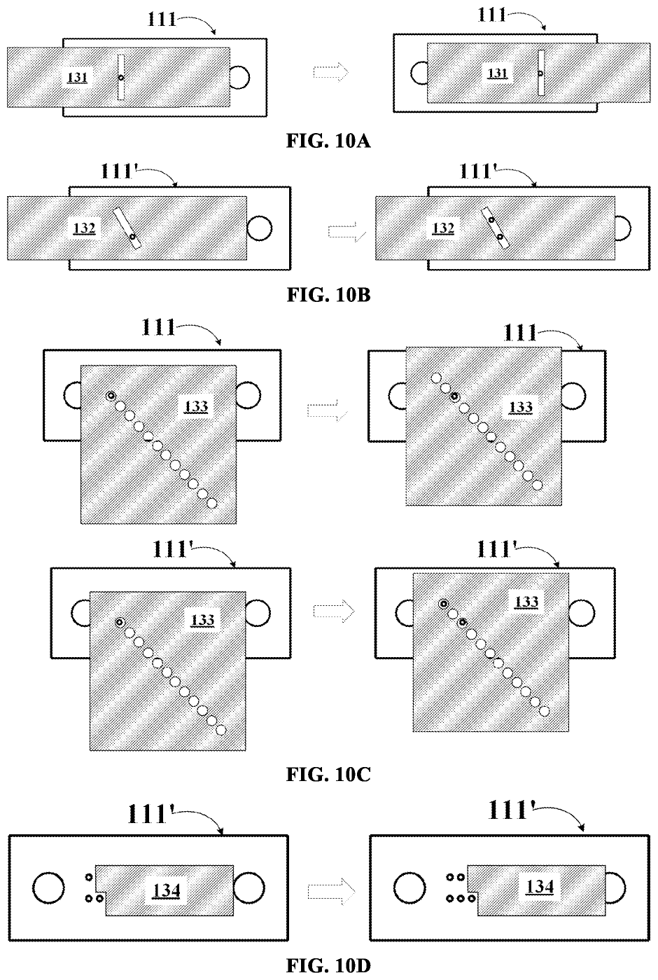

Of course, apart from the baffle 130′ having a diagonal, the baffle 130′ can also be in other suitable shapes for polarity testing of MPO optical cables with a high core number. FIG. 10A to FIG. 10D schematically depict examples of the baffle used by the polarity test system according to some other embodiments of the present disclosure. In which, the baffle 134 with inclined serrated edges as shown in FIG. 10D can also be used for polarity testing of 24-core MPO optical cables very well. It can certainly be used for the polarity testing of 12-core MPO optical cables as well. In addition, the baffle shown in FIG. 10A to FIG. 10C can also have a structure with grooves or holes. For example, the baffle 131 in FIG. 10A has vertical grooves for the ease of polarity testing of MPO optical cables with a single row of optical fiber ends on the end-face, while the baffle 132 in FIG. 10B has inclined grooves for the ease of polarity testing of MPO optical cables with one row or a plurality of rows of optical fiber ends on the end-face. In addition, the baffle 133 in FIG. 10C has a plurality of holes arranged along the incline for the ease of polarity testing of MPO optical cables with one row or a plurality of rows of optical fiber ends on the end-face. It can be understood by those skilled in the art that these are only exemplary and not limiting. As mentioned above, in general, it is only necessary to ensure that the first end of different optical fibers in the MPO optical cable 110 is blocked by the baffle 130 as the baffle moves relative to the first end-face of the MPO optical cable, and in order to further test the polarity of MPO optical cables with a plurality of rows of optical fiber ends on the end-face, the baffle can be configured to have different distribution of first ends in the respective rows blocked by the baffle in all rows of first ends when the baffle at least partially blocks the first ends at the first end-face (for example, the number of first ends blocked by the baffle among all rows of first ends is different (for example, baffles 130′ and 134) or first ends in all rows of first ends are blocked by the baffle at different positions (for example, baffles 132 and 133)). The specific shape of the baffle can be set based on these purposes.

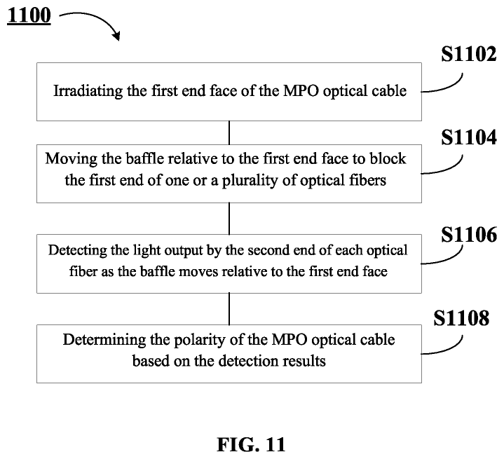

The polarity test method 1100 used for MPO optical cables according to the present disclosure will be described in detail below with reference to FIG. 11. Method 1100 comprises: at Step S1102, irradiating the first end-face of the MPO optical cable so that light can enter the optical fibers through the first end of a plurality of optical fibers of the MPO optical cable and leave through the second end of the optical fibers; at Step S1104, moving the baffle relative to the first end-face of the MPO optical cable to block the first end of one or a plurality of optical fibers among the plurality of optical fibers of the MPO optical cable, where this baffle is configured to change the nature of light received by the optical fiber which first end is blocked by the baffle; at Step S1106, detecting the light output by the second end of each optical fiber among the plurality of optical fibers of the MPO optical cable as the baffle moves relative to the first end-face; and at Step S1108, determining the polarity of the MPO optical cable based on the detection results. In some embodiments, the polarity of the MPO optical cable is determined based on the detection results and the sequence in which the first ends are blocked by the baffle. In some embodiments, the polarity of the MPO optical cable is determined based on the detection results and the direction in which the baffle moves relative to the first end-face. In some embodiments, the polarity of the MPO optical cable is determined based on the detection results and the position of the baffle relative to the first end-face.

The polarity test system and method according to the present disclosure can test the polarity of MPO optical cables using a non-contact method, effectively preventing MPO optical cables from being damaged or contaminated during polarity testing, and they can be easily adapted to MPO optical cables with various core number designs. In addition, the polarity test system and method according to the present disclosure only require a pair of light sources and detection devices, and do not require test leads, so the cost is low and the operations are simple.

The terms “left”, “right”, “front”, “rear”, “top”, “bottom”, “upper”, “lower”, “high”, “low” in the descriptions and claims, if present, are used for descriptive purposes and not necessarily used to describe constant relative positions. It should be understood that the terms used in this way are interchangeable under appropriate circumstances, so that the embodiments of the present disclosure described herein, for example, can operate on other orientations that differ from those orientations shown herein or otherwise described. For example, when the device in the drawing is turned upside down, features that were originally described as “above” other features can now be described as “below” other features. The device may also be oriented by other means (rotated by 90 degrees or at other locations), and at this time, a relative spatial relation will be explained accordingly.

In the descriptions and claims, when an element is referred to as being “above” another element, “attached” to another element, “connected” to another element, “coupled” to another element, or “contacting” another element, the element may be directly above another element, directly attached to another element, directly connected to another element, directly coupled to another element, or directly contacting another element, or there may be one or multiple intermediate elements. In contrast, if an element is described “directly” “above” another element, “directly attached” to another element, “directly connected” to another element, “directly coupled” to another element or “directly contacting” another element, there will be no intermediate elements. In the descriptions and claims, a feature that is arranged “adjacent” to another feature, may denote that a feature has a part that overlaps an adjacent feature or a part located above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “basically” means comprising any minor changes caused by design or manufacturing defects, device or component tolerances, environmental influences, and/or other factors. The word “basically” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “include/comprise” is used in this text, it indicates the presence of the specified feature, entirety, step, operation, unit and/or component, but does not exclude the presence or addition of one or more other features, entireties, steps, operations, units and/or components and/or combinations thereof.

In the present disclosure, the term “provide” is used in a broad sense to cover all ways of obtaining an object, so “providing an object” includes but is not limited to “purchase”, “preparation/manufacturing”, “arrangement/setting”, “installation/assembly”, and/or “order” of the object, etc.

As used herein, the term “and/or” includes any and all combinations of one or more of the associated listed items. The terms used herein are only for the purpose of describing specific embodiments, and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed in the additional operation, and the operations can be executed at least partially overlapping in time. Also, alternative embodiments may include multiple instances of specific operations, and the order of operations may be changed in other various embodiments. However, other modifications, changes and substitutions are also possible. Aspects and elements of all embodiments disclosed above may be combined in any manner and/or in conjunction with aspects or elements of other embodiments to provide multiple additional embodiments. Therefore, the Specification and attached drawings hereof should be regarded as illustrative rather than limitative.

Although some specific embodiments of the present disclosure have been described in detail through examples, those skilled in the art should understand that the above examples are only for illustration rather than for limiting the scope of the present disclosure. The embodiments disclosed herein can be combined arbitrarily without departing from the spirit and scope of the present disclosure. Those skilled in the art should also understand that various modifications can be made to the embodiments without departing from the scope and spirit of the present disclosure. The scope of the present disclosure is defined by the attached claims.

What is claimed is:

1. A polarity test system used for multi-fiber push on (MPO) optical cables, where the MPO optical cable comprises a first end-face, a second end-face and a plurality of optical fibers extended between the first end-face and the second end-face, with each optical fiber comprising a first end arranged at the first end-face and a second end arranged at the second end-face, and the polarity test system comprises:
a light source, configured to irradiate the first end-face of the MPO optical cable so that the light transmitted from the light source enters the plurality of optical fibers from the first end of the plurality of optical fibers and leaves the plurality of optical fibers from the second end of the plurality of optical fibers;
a baffle, set between the light source and the first end-face of the MPO optical cable that can move relative to the first end-face to block the first end of one or a plurality of optical fibers among the plurality of optical fibers, and the baffle is configured to change the nature of light received by the optical fibers which first end is blocked by the baffle among the plurality of optical fibers; and
a detection device, configured to detect the light output by the second end of each optical fiber among the plurality of optical fibers as the baffle moves relative to the first end-face.

2. A polarity test system according to claim 1, which further comprises a processing device, configured to determine the polarity of the MPO optical cable based on the detection results of the detection device and the sequence in which the first ends are blocked by the baffle.

3. A polarity test system according to claim 1, which further comprises a processing device, configured to determine the polarity of the MPO optical cable based on the detection results of the detection device and the direction in which the baffle moves relative to the first end-face.

4. A polarity test system according to claim 1, which further comprises a processing device, configured to determine the polarity of the MPO optical cable based on the detection results of the detection device and the position of the baffle relative to the first end-face.

5. A polarity test system according to claim 1, in which, the baffle is configured to attenuate the intensity of light received by the optical fiber which first end is blocked by the baffle among the plurality of optical fibers

6. A polarity test system according to claim 1, in which, the baffle is configured to change the wavelength of the light received by the optical fiber which first end is blocked by the baffle among the plurality of optical fibers.

7. A polarity test system according to claim 1, in which, the detection device is an imaging device and the imaging device is configured to capture images of the second end-face of the MPO optical cable as the baffle moves relative to the first end-face.

8. A polarity test system according to claim 1, in which, the detection device comprises a plurality of detection units, with each detection unit configured to receive light output from a corresponding second end among the second ends of the plurality of optical fibers.

9. A polarity test system according to claim 1, in which,
the number of optical fibers which first end is blocked by the baffle among the plurality of optical fibers increases as the baffle moves relative to the first end-face, or
the number of optical fibers which first end is blocked by the baffle among the plurality of optical fibers decreases as the baffle moves relative to the first end-face.

10. A polarity test system according to claim 1, in which, the first ends at different positions on the first end-face are blocked by the baffle as the baffle moves relative to the first end-face.

11. A polarity test system according to claim 1, in which, the first end of the plurality of optical fibers is arranged in multiple rows at the first end-face, and the second end of the plurality of optical fibers is arranged in multiple rows at the second end-face, with the number of rows of first ends being the same as that of second ends.

12. A polarity test system according to claim 11, in which, the baffle is configured to block different numbers of first ends in all rows of first ends when the baffle at least partially blocks the first ends at the first end-face.

13. A polarity test system according to claim 11, in which, the baffle is configured to block first ends at different positions in all rows of first ends when the baffle at least partially blocks the first ends at the first end-face.

14. A polarity test method used for multi-fiber push on (MPO) optical cables, where the MPO optical cable comprises a first end-face, a second end-face and a plurality of optical fibers extended between the first end-face and the second end-face, with each optical fiber comprising a first end arranged at the first end-face and a second end arranged at the second end-face, and the polarity test method comprises:
irradiating the first end-face of the MPO optical cable so that light can enter the plurality of optical fibers through the first end of the plurality of optical fibers and leave the plurality of optical fibers through the second end of the plurality of optical fibers;
moving the baffle relative to the first end-face to block the first end of one or a plurality of optical fibers among the plurality of optical fibers, where the baffle is configured to change the nature of light received by the optical fiber which first end is blocked by the baffle among the plurality of optical fibers;
detecting the light output by the second end of each optical fiber among the plurality of optical fibers as the baffle moves relative to the first end-face; and
determining the polarity of the MPO optical cable based on the detection results.

15. A polarity test method according to claim 14, in which, the polarity of the MPO optical cable is determined based on the detection results and the sequence in which the first ends are blocked by the baffle.

16. A polarity test method according to claim 14, in which, the polarity of the MPO optical cable is determined based on the detection results and the direction in which the baffle moves relative to the first end-face.

17. A polarity test method according to claim 14, in which, the polarity of the MPO optical cable is determined based on the detection results and the position of the baffle relative to the first end-face.
